(19) United States
(12) Patent Application Publication
(10) Pub. No.: US 2010/0052546 A1
(43) Pub. Date: Mar. 4, 2010

(54) Method and Apparatus for Mounting and Assembling LED Lens Assemblies in Electronic Displays

(75) Inventors: John S. Williams, Las Vegas, NV (US); Richard A. Petersen, Las Vegas, NV (US)

Correspondence Address: TRASKBRITT, P.C., P.O. BOX 2550, SALT LAKE CITY, UT, 84110, US

(73) Assignee: Young Electric Sign Company, Salt Lake City, UT (US)

(21) Appl. No.: 12/199,408

(22) Filed: Aug. 27, 2008

(51) Int. Cl. H05B 37/02; F21V 5/00; H01S 4/00

(52) U.S. Cl. 315/152; 315/158; 362/244; 29/592.1; 362/249.07; 362/311.05

(57) ABSTRACT

Lighting elements include light emitting diodes mounted on a circuit board with a lens assembly that may be positioned substantially near the light emitting diode to allow light from the light emitting diode to pass through a lens portion of the lens assembly. The lens assembly includes a connecting base piece to detachably connect the lens assembly to the circuit board. A method of connecting a lens to a circuit board may also include placing a lens assembly including the lens over a light emitting diode and detachably connecting the lens to the circuit board by detachably connecting a base piece of the lens assembly to the circuit board.

### BACKGROUND OF THE INVENTION

1. Field of the Invention

The present invention relates to electronic displays. More specifically, the present invention relates to connecting one or more light emitting diodes (LED) and a lens to a printed circuit board contained within an electronic display.

2. State of the Art

Electronic signs can be used in many different applications. Electronic signs may display patterns to generally draw attention to an area such as a game machine, or an advertisement. Text or animated video may also be presented on electronic displays. In some electronic displays, LEDs may be used to create these effects. FIG. 1 illustrates one conventional approach to illuminating an LED as part of a larger display system. FIG. 1 illustrates a lighting element 100 which includes a circuit board 110, a lens 120, an LED 130 disposed within the lens 120, leads 140, and a support tube 150. The LED 130 is built into the lens 120 and is electrically connected to the circuit board 110. The lens includes an outer ledge 170. The support tube 150 may be used to provide more space between the circuit board 110 and the tip of the lens 120. Having more space between the circuit board 110 and the tip of the lens 120 may be helpful when connecting the lighting element 100 to a larger display system. The support tube 150 surrounds the leads of the LED 130 to fix the LED 130 and lens 120 in a stable position.

When implemented in a display, such as an electronic sign, the lens 120 extends through an aperture in the display such that a tip is viewed from the outside of the display. A clip with a hole therethrough is also placed through an aperture in the display such that the lens 120 fits inside the hole in the clip when placed through the aperture. The clip extends beyond the outer ledge 170 of the lens 120 and snaps the lens 120 into position with the display. One disadvantage of conventional approaches is that once an LED is mounted on the circuit board, the lens is essentially a part of the circuit board and to change or replace the lens would often require discarding the entire board including the LED.

Conventional displays additionally are limited by the number of LEDs that are on an individual board. Conventional systems have displays that implement circuit boards that each have the same number of LEDs as each other. This lack of flexibility thus limits the possible effects to be displayed. Thus, there is a need for a more flexible and modular apparatus and method for mounting new LEDs in a display system.

### BRIEF SUMMARY OF THE INVENTION

An embodiment of the present invention comprises a lighting element including a light emitting diode mounted on a circuit board and a lens assembly. The lens assembly includes a connecting base piece coupled to a lens piece, wherein the connecting base piece detachably connects to the circuit board substantially near the light emitting diode and the lens piece is configured and positioned such that light from the light emitting diode will substantially transmit through the lens piece.

Another embodiment of the present invention comprises a lighting strip including a plurality of light emitting diodes mounted on a circuit board and a plurality of lens assemblies. Each lens assembly is configured for detachable coupling to the circuit board substantially near one of the plurality of light emitting diodes. Each lens assembly includes a connecting base piece configured to detachably connect to the circuit board and a lens piece coupled to the connecting base piece such that one end of the lens piece is positioned substantially near the one of the plurality of light emitting diodes. The lens piece is configured to transmit light from the one of the plurality of light emitting diodes.

Another embodiment of the present invention is a method of assembling a lighting element for a display system. The method includes coupling at least one light emitting diode to a circuit board. The method also includes detachably connecting at least one lens assembly to the circuit board with the at least one lens assembly positioned substantially near the at least one light emitting diode and configured such that light from the at least one light emitting diode passes through a lens within the lens assembly.

Another embodiment of the present invention is a method of securing a lighting element to a display system. The method includes coupling at least one light emitting diode to a circuit board. The method also includes detachably connecting at least one lens assembly to the circuit board with the at least one lens assembly positioned substantially near the at least one light emitting diode and configured such that light from the at least one light emitting diode passes through a lens within the lens assembly. The method also includes securing the at least one lens assembly through an aperture in an electronic display.

Yet another embodiment of the present invention is an electronic display system including at least one display surface including at least one aperture formed therethrough. At least one lighting element extends through the at least one aperture of the display surface and includes a light emitting diode mounted on a circuit board and a lens assembly. The lens assembly includes a connecting base piece coupled to a lens piece, wherein the connecting base piece detachably connects to the circuit board substantially near the light emitting diode and the lens piece is configured and positioned such that light from the light emitting diode will substantially transmit through the lens piece.

These features, advantages, and alternative aspects of the present invention will be apparent to those skilled in the art from a consideration of the following detailed description taken in combination with the accompanying drawings.

### BRIEF DESCRIPTION OF THE SEVERAL VIEWS OF THE DRAWINGS

In the drawings:

FIG. 1 illustrates one conventional approach to illuminating an LED in a larger display system;

FIG. 2 illustrates a front view of a lighting element in a single LED configuration according to an embodiment of the present invention;

FIG. 3 illustrates a top view of a lighting element in a single LED configuration according to an embodiment of the present invention;

FIG. 4 illustrates a lighting strip including a plurality of lighting elements contained within a single board according to an alternative embodiment of the present invention;

FIG. 5 illustrates a display system in which the lighting element may be implemented; and

FIG. 6 illustrates a block diagram of a display system implementing a number of lighting elements and lighting strips according to an embodiment of the present invention.

### DETAILED DESCRIPTION OF THE INVENTION

The present invention, in a number of embodiments, includes improvements over several features of conventional lighting elements used in electronic displays. Conventional lighting elements used in electronic displays are limited in their controllability, interchangeability, and use in modular display systems. Having an LED built into the lens and electrically connected to the circuit board may require the entire circuit board to be replaced if the lens is damaged, or also if the length of the lens is desired to be a different length in order to show a greater or lesser portion of the tip of the lens protruding from the display itself.

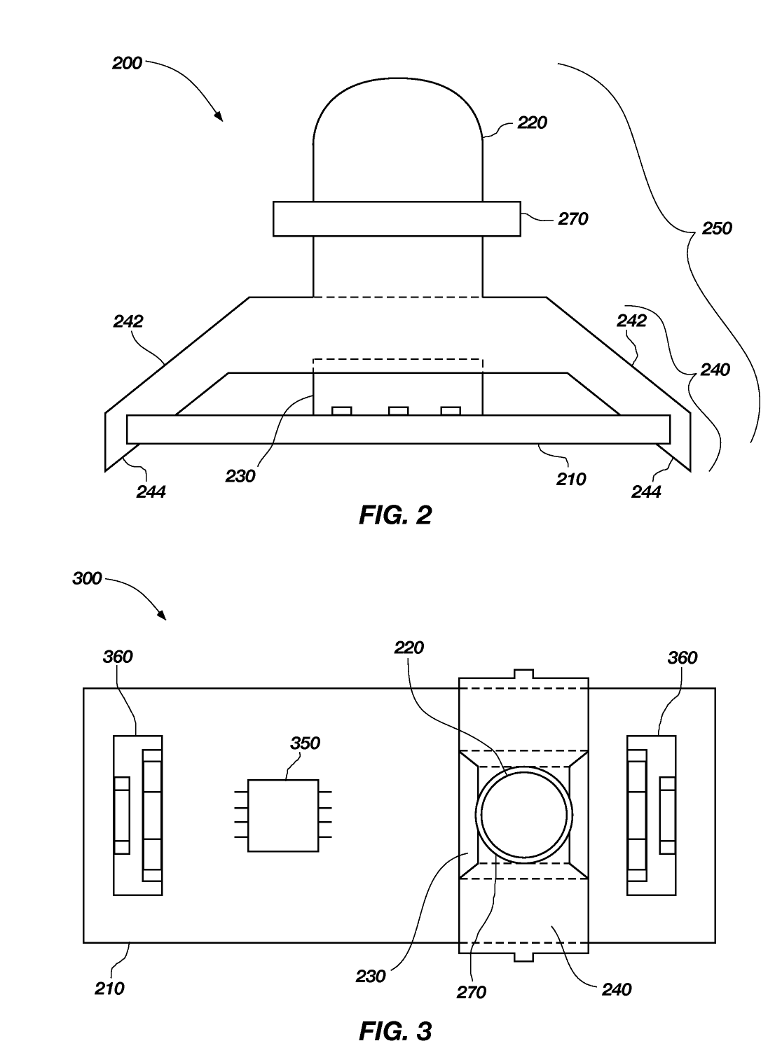

FIG. 2 illustrates a front view of a lighting element 200 as part of a single LED configuration according to an embodiment of the present invention. As shown in FIG. 2, lighting element 200 includes a circuit board 210, lens assembly 250, and LED 230. The lens assembly 250 may include a lens 220 and a connecting base piece 240 suitably coupled together. The lens 220 may include an outer ledge 270.

The LED 230 may be mounted on the circuit board 210 by methods known in the art. The connecting base piece 240 detachably connects the lens assembly 250 to the circuit board 210. The connecting base piece 240 may have two base clips 242 extending around opposite sides of the circuit board 210. At the end of the two base clips 242, there may be end flanges 244 extending along a portion of an underside of the circuit board 210 such that the lens assembly 250 is held firmly in place relative to the LED 230. The two base clips 242 are flexible enough such that the base clips can deform outwardly enough to allow the end flanges 244 to wrap around the circuit board 210 then return to their original position such that the end flanges 244 fit securely around a portion of an edge of the circuit board 210.

The base clips 242 and end flanges 244 are one embodiment for detachably coupling the lens assembly 250 to the circuit board 210. Other detachable couplings are contemplated as within the scope of the present invention. By way of non-limiting example, a plastic (or other suitable material) sockets may be affixed to the top side of the circuit board 210 on opposite sides of the LED 230. The lens assembly may include pins configured to “press-fit” into the sockets to form the secure, but detachable, attachment between the circuit board 210 and the lens assembly 250. Of course, the pin and socket may be reversed such that pins are mounted on the circuit board 210 and sockets are present as part of the lens assembly 250.

When the lens assembly 250 is held in place, the lens 220 is positioned over the LED 230. The lens assembly 250 may be positioned such that one end of the lens 220 is positioned substantially near the LED 230 such that light from the LED will transmit through the lens 220. Alternatively, the lens assembly 250 may be configured to fit directly over and substantially covering the LED 230.

The lens 220 and connecting base piece 240 may be manufactured as a single piece to form the lens assembly 250. Alternatively, the connecting base piece 240 and the lens 220 may be formed separately and coupled together to form the lens assembly 250. Coupling may be performed by any suitable means, such as, for example, epoxy, press fit, thermal fusion, and the like.

The lens assembly 250, or at least the lens 220 portion of the lens assembly 250, may be transparent. Alternatively, the lens 220, lens assembly 250, or combination thereof may be colored, slightly opaque, translucent, or combinations thereof.

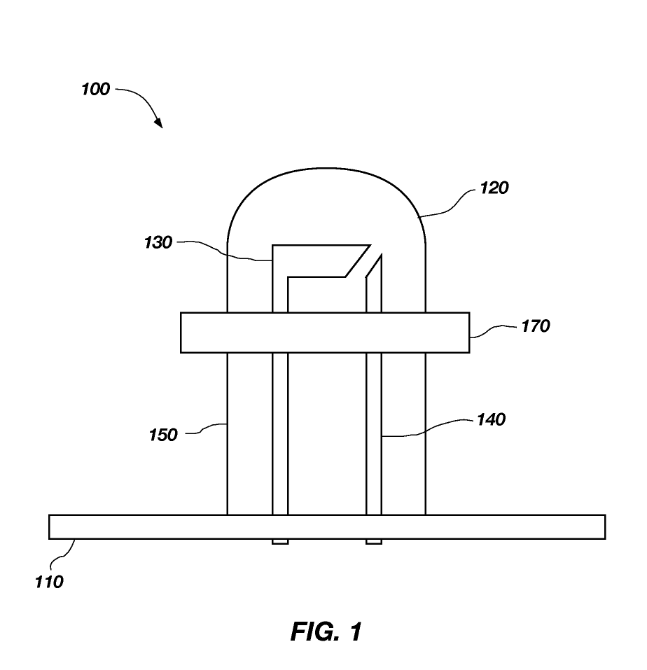

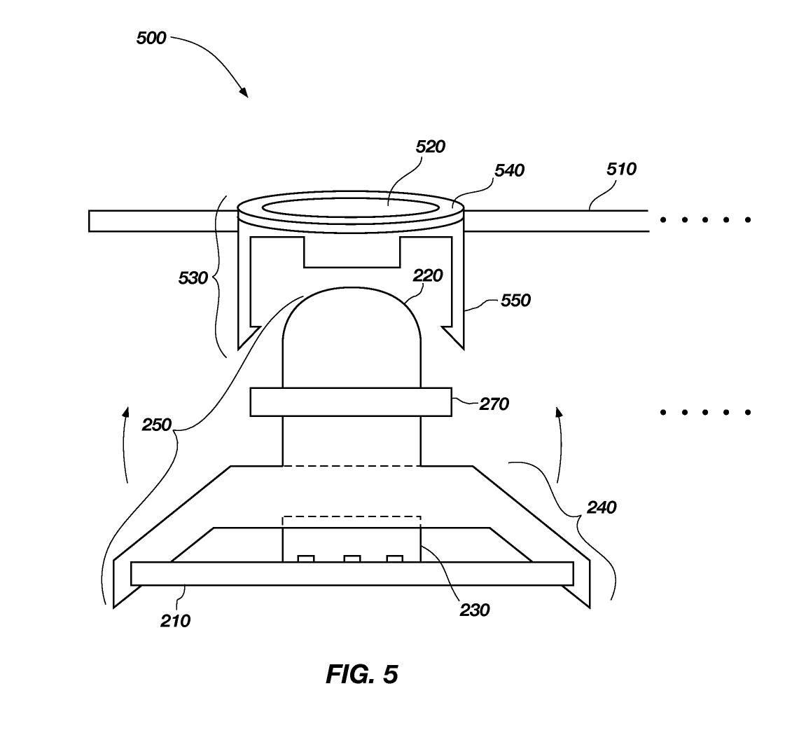

In one embodiment of the present invention, the dimensions of the lens 250 and the placement of the outer ledge 270 may be such that the lighting element 200 may be retrofitted to replace conventional lighting elements (such as those shown in FIG. 1) used in current electronic displays without being required to manufacture a new display. Placement and function of the outer ledge is explained more fully below with reference to FIG. 5. The conventional lighting elements implemented in an electronic display can be switched out in favor of the improved lighting elements to upgrade the electronic display to have the advanced controllability found in embodiments of the present invention. For new displays, the dimensions of the lens assembly 250 and the outer ledge 270 may vary according to the size and design preferences for the electronic display.

LED 230 may be a multi-colored LED. A multi-colored LED may include red, green, and blue die in the same optical enclosure which may be controlled and combined to render over 16 million colors. Red, green, blue is a standard combination of primary colors in electronic displays, however, other color combinations are within the scope of the present invention to form a multi-colored LED. LED 230 may alternatively be a single-colored LED, or a cluster of smaller LEDs may lie underneath a single detachable lens. While the lens 220 may have an outer ledge 270 for retrofitability with existing displays, other alternatives exist to secure the lens 220 into place with the display. For example, one skilled in the art would recognize that an indentation or slit in the lens 220 may likewise be used to engage the lens 220 with a mounting clip when it extends through the display aperture. Details of the mounting clip are discussed below in reference to FIG. 5.

FIG. 3 illustrates a top view of a lighting element 300 in a single LED configuration according to an embodiment of the present invention. Lighting element 300 includes a circuit board 210, lens 220, LED 230, connecting base piece 240, a driver 350, and one or more communication ports 360. The lens 220 may also include an outer ledge 270 extending out from the perimeter of a portion of the lens 220.

The LED 230 may be mounted on the circuit board 210. The connecting base piece 240 detachably connects the lens 220 to the circuit board 210 as described in the description accompanying FIG. 2. The LED 230 may be operably coupled with the driver 350, which is in communication with the communication port 360.

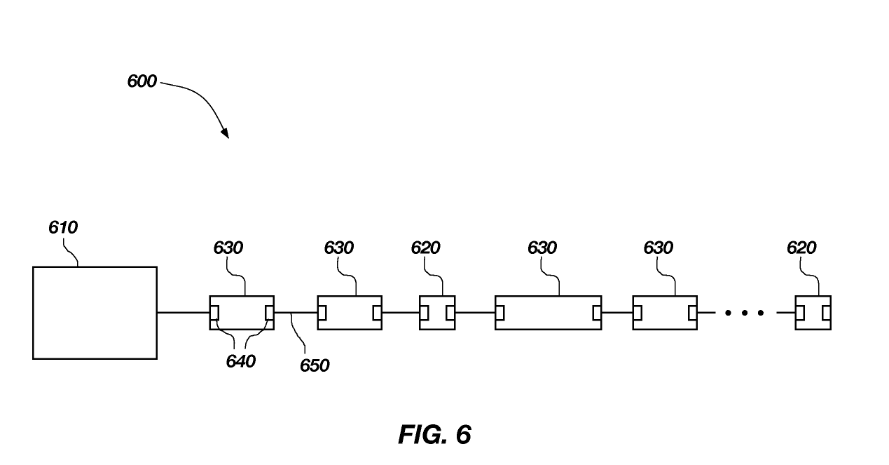

As one example of possible operation, a data packet may be received serially by the driver 350 through communication port 360 from a control unit (not shown) and stored in an internal shift register of the driver 350. A second communication port 360 may also be present on the circuit board 210 to connect with another lighting element in a larger display system with a conductor cable (not shown) used to connect lighting elements as will be shown in FIG. 6. Once the data packet is sent through to the drivers of each lighting element in the system, a latch signal may be sent to the driver 350 to latch light information for the LED 230 associated with the driver 350 and sent from the control unit. Each LED in the system may receive different light information and therefore differ from each other in color and intensity. The light information may include information for controlling the intensity of the LED, color of the LED, or combinations thereof.

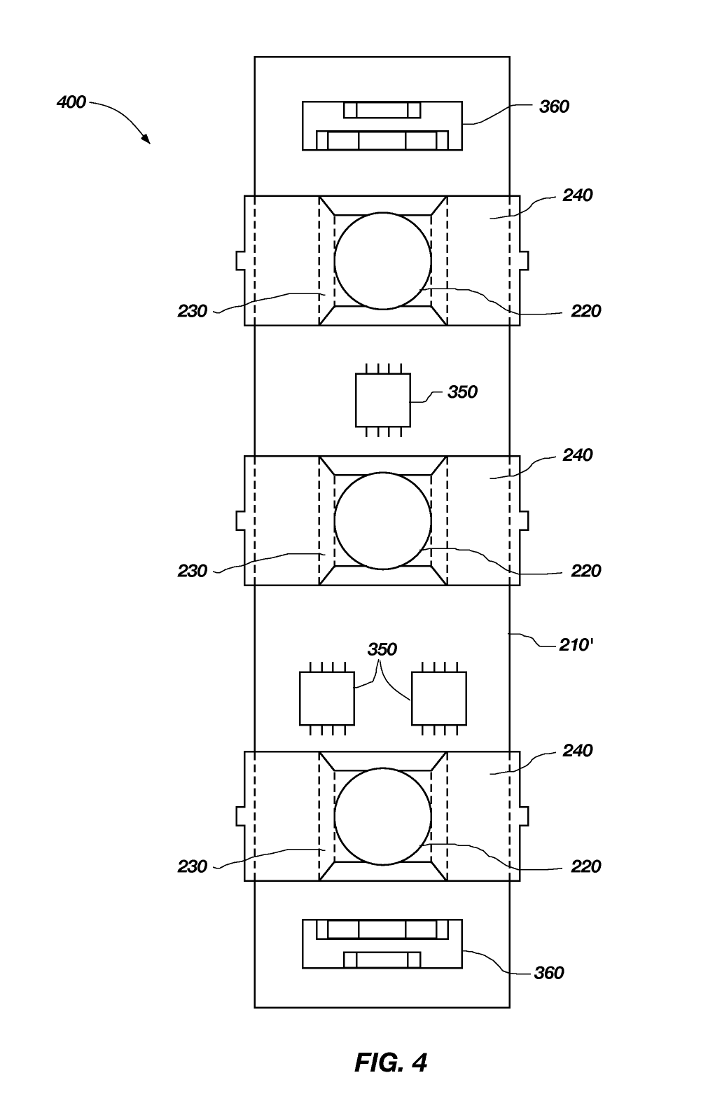

FIG. 4 illustrates a lighting strip 400 including a plurality of lighting elements contained within a single circuit board 210′ according to another embodiment of the present invention. The lighting strip 400 includes a circuit board 210′, a plurality of lenses 220 coupled to a plurality of connecting base pieces 240, a plurality of LEDs 230, plurality of drivers 350, and one or more communication ports 360.

The lighting strip 400 may be configured in a similar manner to a single lighting element such as in FIG. 2. By way of example, and not limitation, the lighting strip 400 may comprise three LEDs 230 mounted on the circuit board 210′, each LED 230 coupled with a driver 350. Each LED 230 may have a lens 220 placed above it and a connecting base piece 240 that connects each lens 220 to the circuit board 210′. The plurality of connecting base pieces 240 may extend around the sides of the circuit board 210′ and along a portion of the underside of the circuit board 210′ to connect each of the plurality of lenses 220 into place over each of the plurality of LEDs 230 as was explained above with reference to FIG. 2. The connecting base pieces 240 may therefore be detachably connected to the circuit board 210′ with the each of the plurality of lenses 220 over each of the plurality of LEDs 230 such that light from the plurality of LEDs 230 may transmit through the plurality of lenses 220.

In some embodiments, the lighting strip 400 may include groups of three or six lighting elements on a single circuit board. However, one skilled in the art would recognize that any number of lighting elements may be implemented in a group on a single circuit board. The lighting strip 400 may operate as one control group with the LEDs 230 acting in unison based on a single packet of serial data being sent in parallel to each of the plurality of drivers 350. The plurality of drivers 350 drive the LEDs 230 based on the single data packet when a latch signal is sent by the control unit.

Alternatively, each LED 230 on the lighting strip 400 may be individually controlled As a non-limiting example, the drivers 350 may be coupled in a serial fashion such that each driver can be individually addressed with color and intensity information and each driver 350 controls its associated LED 230 with the light information for that LED.

FIG. 5 illustrates a display system 500 in which lighting elements 200, 300 and lighting strip 400 may be implemented. The display system may include a display sheet 510 with at least one aperture 520 and a mounting clip 530. The mounting clip 530 fits through the aperture 520 of the display sheet 510 such that the mounting clip 530 has a flat ring piece 540 that remains viewable from the outside of the display sheet 510 while leg pieces 550 extend through the aperture 520.

When assembled, a lens 220 from lighting elements 200, 300 or lighting strip 400 couples to the display system 500 by passing the tip of the lens 220 through the mounting clip 530 and the aperture 520 such that the tip of the lens 220 extends above the display sheet 510 and is viewed from the outside of the display sheet 510. The flat ring piece 540 may surround the tip of the lens 220 and may be viewable from the outside of the display sheet 510 as well. The leg pieces 550 clip onto the outer ledge 270 securing lighting elements 200, 300 or lighting strip 400 in place. When light is emitted from the LED 230, a viewer may only see the light that is passed through the tip of the lens 220.

A combination of more than one singular lighting element may be used in display system 500. In such an embodiment each lighting element is singular on its own circuit board and used in combination to create the desired effect. Alternatively, circuit boards may be implemented in a display system combining more than one lighting element on a single board to create a chosen pattern such as with the lighting strip 400 of FIG. 4. In yet another embodiment, a display system 500 may use a combination of singular lighting elements with lighting strips with more than one lighting element on a circuit board in order to create the desired effect. Each lighting element, lighting strip, or combination thereof may be connected with conductor cables connecting to communication ports on each circuit board. The modularity of the number of LEDs on a single circuit board and the ability to combine single lighting elements with lighting strips of different lengths provide the user with a wider variety of display layouts to create different display effects.

FIG. 6 illustrates a block diagram of a display system 600 implementing a number of lighting elements and lighting strips according to an embodiment of the present invention. Display system 600 may include a control unit 610, lighting elements 620, and lighting strips 630. Lighting elements 620 and lighting strips 630 may include communication ports 640. Conductor cables 650 connect the control unit 610 with the string of lighting elements 620 and lighting strips 630 as well as connect the lighting elements 620 and lighting strips 630 with each other through communication ports 640. Conductor cables may also include power and ground terminals to provide power in to the lighting elements 620 and lighting strips 630 in addition to data terminals in order to provide light information.

In operation, the control unit 610 sends a serial signal to the string of lighting elements 620 and lighting strips 630. The signal controls the functionality of the light emitting diodes contained within each lighting element 620 and each lighting strip 630. The control unit 610 may control the intensity of light, the color of light, as well as the start time and length of illumination for the individual lighting element as part of an overall display scheme. As previously stated, a latch signal may also be sent by the control unit 610 to determine when the on-board drivers drive the LEDs on the lighting elements 620 and lighting strips 630 according to the data sent by the control unit 610. The lighting elements may include single LEDs covered by a lens assembly according to embodiments of the present invention. The lighting strips 630 may include a plurality of LEDs and lens assemblies including groups of three, six, or any number according to the specific application and desired effect to be created by a modular design system. The display system 600 may include only a string of single lighting elements 620, or a string only of lighting strips 630. The lighting strips 630 may all have the same number of LEDs or alternatively some lighting strips 630 may be different lengths and have differing numbers of LEDs. The display system may alternatively include any combination of lighting elements 620 and lighting strips 630 with the lighting strips 630 all having the same number of LEDs, or in some situations differing numbers of LEDs.

Although the present invention has been described with reference to particular embodiments, the present invention is not limited to these described embodiments. Rather, the present invention is limited only by the appended claims, which include within their scope all equivalent devices or methods that operate according to the principles of the present invention as described

1. A lighting element for an electronic sign, comprising:
a light emitting diode mounted on a circuit board; and
a lens assembly comprising a connecting base piece coupled to a lens piece, wherein the connecting base piece detachably connects to the circuit board substantially near the light emitting diode and the lens piece is configured and positioned such that light from the light emitting diode will substantially transmit through the lens piece.

2. The lighting element of claim 1, further comprising a driver mounted on the circuit board, configured for receiving light information for controlling at least an intensity of the light emitting diode.

3. The lighting element of claim 2, further comprising at least one communication port operably coupled with the driver and configured to operably couple to a control unit to receive the light information.

4. The lighting element of claim 1, wherein the connecting base piece extends around at least one side of the circuit board.

5. The lighting element of claim 4, wherein the connecting base piece comprises two base clips extending to opposite edges of the circuit board, each base clip including an end flange configured to extend along at least a portion of an underside of the circuit board and secure the connecting base piece to the circuit board.

6. The lighting element of claim 1, wherein the lens piece includes a light transmission characteristic selected from the group consisting of transparent, colored, translucent, at least partially opaque, and combinations thereof.

7. The lighting element of claim 1, wherein the light emitting diode is a multi-color light emitting diode.

8. The lighting element of claim 1, wherein the lens piece comprises an outer ledge disposed circumferentially around the lens piece such that the lens piece is configured to be disposed partially through a hole in a mounting clip and a leg piece of the mounting clip is configured to clip around a portion of the outer ledge to secure the lens piece to a display screen.

9. The lighting element of claim 1, wherein the lens piece and the connecting base piece are formed as a single contiguous piece.

10. A lighting strip, comprising:
a plurality of light emitting diodes mounted on a circuit board; and
a plurality of lens assemblies, each of the plurality of lens assemblies configured for detachable coupling to the circuit board substantially near one of the plurality of light emitting diodes, each of the plurality of lens assemblies comprising:
a connecting base piece configured to detachably connect to the circuit board; and
a lens piece coupled to the connecting base piece such that one end of the lens piece is positioned substantially near the one of the plurality of light emitting diodes and the lens piece is configured to transmit light from the one of the plurality of light emitting diodes.

11. The lighting strip of claim 10, wherein at least one of the plurality of light emitting diodes is a multi-colored light emitting diode.

12. The lighting strip of claim 10, further comprising a plurality of drivers mounted on the circuit board, each of the plurality of drivers operably coupled with one of the plurality of light emitting diodes.

13. The lighting strip of claim 10, further comprising at least one communication port operably coupled with the plurality of drivers and configured to operably couple to a control unit to receive light information sent to drive the light emitting diodes, the plurality of light emitting diodes, or the one of the plurality of light emitting diodes.

14. The lighting strip of claim 10, wherein the connecting base piece of each of the plurality of lens assemblies comprises two base clips extending to opposite edges of the circuit board, each base clip including an end flange configured to extend along at least a portion of an underside of the circuit board and secure the connecting base piece to the circuit board.

15. A method of assembling a lighting element for a display system, the method comprising:
coupling at least one light emitting diode to a circuit board; and
detachably connecting at least one lens assembly to the circuit board with the at least one lens assembly positioned substantially near the at least one light emitting diode and configured such that light from the at least one light emitting diode passes through a lens within the at least one lens assembly.

16. The method of claim 15, wherein connecting the at least one lens assembly comprises extending a connecting base piece around at least one side of the circuit board.

17. The method of claim 15, wherein connecting the at least one lens assembly further comprises coupling at least one end flange to the connecting base piece such that the at least one end flange extends along at least a portion of an underside of the circuit board.

18. A method of securing a lighting element to a display system, the method comprising:
coupling at least one light emitting diode to a circuit board;
detachably connecting at least one lens assembly to the circuit board with the at least one lens assembly positioned substantially near the at least one light emitting diode and configured such that light from the at least one light emitting diode passes through a lens within the at least one lens assembly; and
securing the at least one lens assembly through an aperture in an electronic display.

19. The method of claim 18, wherein securing the at least one lens assembly comprises placing a mounting clip through the aperture in the electronic display and engaging a leg piece of the mounting clip with an outer ledge of the at least one lens assembly.

20. An electronic display system, comprising:
at least one display surface including at least one aperture formed therethrough; and
at least one lighting element extending through the at least one aperture of the at least one display surface, the at least one lighting element comprising:
a light emitting diode mounted on a circuit board; and
a lens assembly comprising a connecting base piece coupled to a lens piece, wherein the connecting base piece detachably connects to the circuit board substantially near the light emitting diode and the lens piece is configured and positioned such that light from the light emitting diode will substantially transmit through the lens piece.

21. The electronic display system of claim 20, further comprising at least one mounting clip, wherein the at least one mounting clip extends through the at least one aperture and engages with the lens assembly to secure the lens assembly to the at least one display surface.

22. The electronic display system of claim 21, wherein the at least one mounting clip engages with a ledge extending out from the lens piece of the lens assembly.

23. The electronic display system of claim 20, wherein the connecting base piece comprises two base clips extending to opposite edges of the circuit board, each base clip including an end flange configured to extend along at least a portion of an underside of the circuit board and secure the connecting base piece to the circuit board.

24. The electronic display system of claim 20, further comprising at least one second lighting element extending through at least one different aperture, wherein the at least one second lighting element and the at least one lighting element are serially connected.

25. The electronic display system of claim 20, further comprising at least one lighting strip operably coupled with the at least one lighting element, the at least one lighting strip comprising:
a plurality of light emitting diodes mounted on a circuit board;
a plurality of lens pieces, each of the plurality of lens pieces positioned over the plurality of light emitting diodes; and
a plurality of base pieces extending around a side of the circuit board and detachably connecting the plurality of lens pieces to the circuit board.

26. The electronic display system of claim 25, further comprising a plurality of combinations of lighting elements and lighting strips extending through apertures in the electronic display system.

27. The electronic display system of claim 26, wherein the plurality of combinations of lighting elements and lighting strips are configured to display video data.
